(19) United States
(12) Patent Application Publication
(10) Pub. No.: US 2024/0286777 A1
(43) Pub. Date: Aug. 29, 2024

(54) Low-Power Remote Drone Launch System

(71) Applicant: Andrew SAGER, Bethesda, MD (US)

(72) Inventor: Andrew SAGER, Bethesda, MD (US)

(21) Appl. No.: 18/114,742

(22) Filed: Feb. 27, 2023

(51) Int. Cl. B64U 70/50; B64U 80/70

(52) U.S. Cl. CPC B64U 70/50; B64U 80/70; B64U 2101/18

(57) ABSTRACT

Embodiments of the discloses system and methods relate to storage and launch systems for unmanned aerial vehicles (UAV). More specifically, they relate to systems that allow for unattended storage and launch regardless of range to the operator. The system comprises a radio for transitioning from a low-power, hibernation state to an active state when a target is identified. This can be useful in asymmetric warfare and is a cost-effective alternative to expensive, modern defense systems.

### FIELD OF INVENTION

Embodiments relate to storage and launch systems for unmanned aerial vehicles (UAV). Embodiments include systems that allow for unattended storage and launch regardless of range to the operator.

### BACKGROUND

Battlefield technology is often very expensive and complicated. The expense and complexity of modern warfare generates a problem with training and finances for the amount of expensive technology that a combatant can afford. The February 2022 Russian invasion of Ukraine is Europe's largest war since World War II. The invasion has dispelled the notion that large-scale ground wars involving world powers are relics of pre-nuclear history. As of August 2022, Russia has taken 48,000 square miles of Ukrainian territory and damaged $100B in infrastructure. Ukrainian allies have pledged over $60B in military and humanitarian aid.

### SUMMARY

Militaries have historically had several ways to strike enemy targets with payloads. Classes of payload delivery system are numerous including: petardier, artillery, manned aircraft, rockets, and drones.

Each payload delivery system presents a unique signature of four key metrics: effect size, range, cost per strike, and accuracy. In the 16th century, explosives (called petards) were delivered to fortifications by hand; this role was called petardier. Artillery innovated on this by delivering similar payloads to targets without the need to carry it there. In the 20th century, manned aircraft were effective payload delivery systems as they provide a strong balance of the presented metrics. Notably, in the 2022 Russia-Ukraine war, surface-launched rockets have been favored, because significant risk to aircraft inflated the cost per strike metric beyond the cost of a single use rocket. Rockets remain expensive, so their target domain is accordingly smaller than manned aircraft in prior conflicts. The scale of the conflict indicates a pressing need for innovative defense products that change the economics of future ground wars.

Despite massive financial and weapons support to Ukraine, the war has remained deadlocked for months. One of the most impactful tools used by the Ukrainians so far is the US HIMARS truck-mounted rocket system. The HIMARS has consistently hit high-value targets far behind the front line. However, the system is expensive to operate; its longest range rockets cost $1 M each. From 1991-2015, Lockheed produced only 3,700 of these rockets largely because of the high costs. The shorter range HIMARS ammunition used in Ukraine is only somewhat cheaper, costing about $200K per rocket, but demand has strained US stockpiles and production capabilities. Accordingly, the HIMARS' expensive ammunition impedes its proliferation by limiting its domain to only expensive targets.

A cheaper, lighter system with comparable range is needed as a natural complement to the HIMARS. However, hitting targets hundreds of miles behind the front line is a difficult problem. Rockets are good at quickly launching a payload long distances. The other option is to launch the payload only a short distance, such as from an aircraft. Fairchild's A-10 aircraft has excelled in that role; in asymmetric conflicts, attack aircraft are cost effective because risk of damage to aircraft is low. However, in symmetric conflicts, cost per strike by aircraft is inflated because the risk of damage is high. There are therefore needs for innovative approaches to strike targets more cheaply.

One such system may be collocated with targets, use a cheap and disposable launch platform, and complement the HIMARS target domain with smaller, less valuable targets. Embodiments of the present disclosure include an all-weather, forward-deployed (pre-installed) launch system for loitering munitions (LM). The system may be disposable and carry multiple LMs having, for example, a half-pound payload, or different payloads per LM. When activated by, for example, cellular signals, satellite, or long-distance radio array, the system may be controlled securely from anywhere on the planet, supporting, for example, pre-programmed routes, first-person video control, or both, of each LM. Each system may comprise a usable lifespan of 10 or more years across a wide range of climates and conditions.

Embodiments may be difficult for an enemy to locate, which makes them suitable for extended deployment during peacetime in contentious, sparsely populated border regions. Because common drones can fly 10 or more miles, embodiments can be hidden anywhere in a strike area while being indistinguishable visually from civilian equipment. In response to an invasion, additional systems can be quickly and discreetly placed if land is ceded, incrementally expanding the addressable target area to any and all lost territory.

Embodiments comprise a weather-resistant or, preferably, waterproof pod and one or a plurality of attritable unmanned aerial vehicles (UAV). While the pod is closed, the pod and drones exist in a hibernating, low-power state. The pod may have one or more power supplies that provide reliability and longevity from primary cell batteries or from the grid. Following some signal or condition, the pod opens and, possibly with additional signals or conditions, can deploy one or more UAVs. Depending on configuration, the UAV can be controlled by a one-way or two-way communication link to the operator. One-way communication can be used to set a UAV to deliver a payload to a particular target. Two-way communication can allow for real-time control of the UAV via, for example, a video feed and remote control. One or more sides of the pod may be camouflaged and/or shielded to diminish its discoverability. In preferable embodiments, a phased array microwave antenna allows for high-bandwidth communications to LEO satellites.

The enclosed UAVs can execute one or more flights. In the single flight configuration, a UAV delivers a payload, possibly kinetic or explosive, to the intended target, ending the flight. In the multiple flight configuration, the UAV may fly from target to target delivering payloads.

Embodiments address the problems raised by expensive and complicated battlefield technology. Because of its configuration, embodiments are particularly long-lived as compared to existing drone art and so can remain latent until targets become co-located, rather than bringing the payload a long way such as with a rocket or an aircraft.

Some embodiments may allow transporting a payload to within inches of its target for less than 1/100th the cost of the HIMARS' long-range rockets and, per square mile of coverage, the system is more than 50% cheaper. Accordingly, these embodiments change the economics of ground war between neighboring countries in favor of the defenders. The system effectively complements the HIMARS by expanding the domain of long-range targets to include low-value assets like rail cars and trucks. These embodiments will save lives by making war significantly harder in future symmetric conflicts.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 illustrates a possible embodiment of the power delivery interconnects of the pod.

FIG. 2 illustrates a possible embodiment of the data networking communication interconnects of the pod, including interactions with systems external to the pod.

FIG. 3 illustrates a top down view of a possible embodiment of the system, sans the upper housing, lid and insulation of the pod.

FIG. 4 illustrates a side view of the embodiment shown in FIG. 3, demonstrating how a UAV may be oriented on a launch rail.

FIG. 5 illustrates five possible configurations for the un-sealing of the pod as it transitions from hibernation to activity.

FIG. 6 illustrates an aquatic embodiment of the system where potentially retractable pontoons allow for the system to launch UAVs on the surface of a body of water.

FIG. 7 illustrates an embodiment of the pod while the system is hibernating. The pod is fully sealed and includes an overhanging lid.

FIG. 8 illustrates an embodiment of the satellite system's sub-pod in a hibernating state while active.

FIG. 9 illustrates an embodiment of the satellite system's sub-pod in an active state.

FIG. 10 Illustrates a flow diagram illustrating one embodiment of the deployment of a UAV during the activity period.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes a system and apparatus comprising a processor coupled to a memory and powered by a long-life battery. The system may include a transceiver that monitors one or more channels for a message, such as a launch message. Upon receiving the launch message, the system may launch a launch vehicle based on a location stored in the launch message.

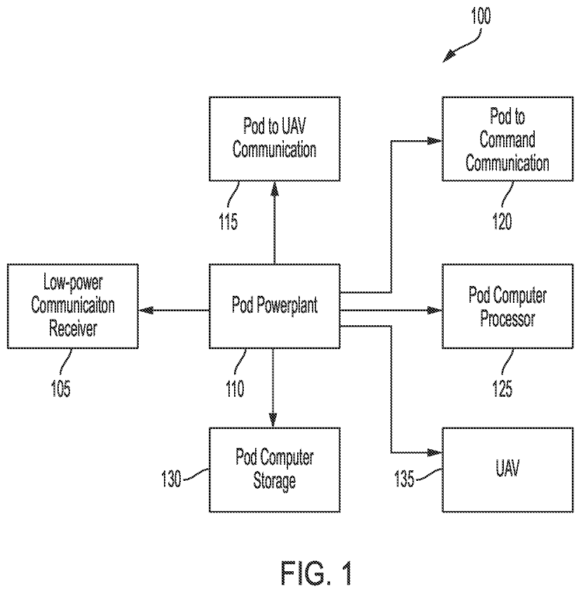

FIG. 1 illustrates example power interconnects and components of the pod 100. The pod powerplant 110 may be enclosed within the storage and launch pod for providing power to other components. During hibernation, the powerplant 110 may provide power to the low-power communication receiver 105, and, in response to a signal or condition, also may provide power to the pod computer processor 125, pod computer storage 130, and the one or plurality of UAVs that may be enclosed within the pod 135. During activity, the powerplant 110 may further provide power to the Pod to UAV communication system 115 and the Pod to Command communication system 120. Alternatively, all communications could be performed through a single radio. In some embodiments, the pod powerplant 110 uses primary cell batteries, but, in any embodiments, the pod powerplant 110 may also use secondary cell batteries, fuel cells, external power sources, and may recharge secondary cell batteries with solar panels.

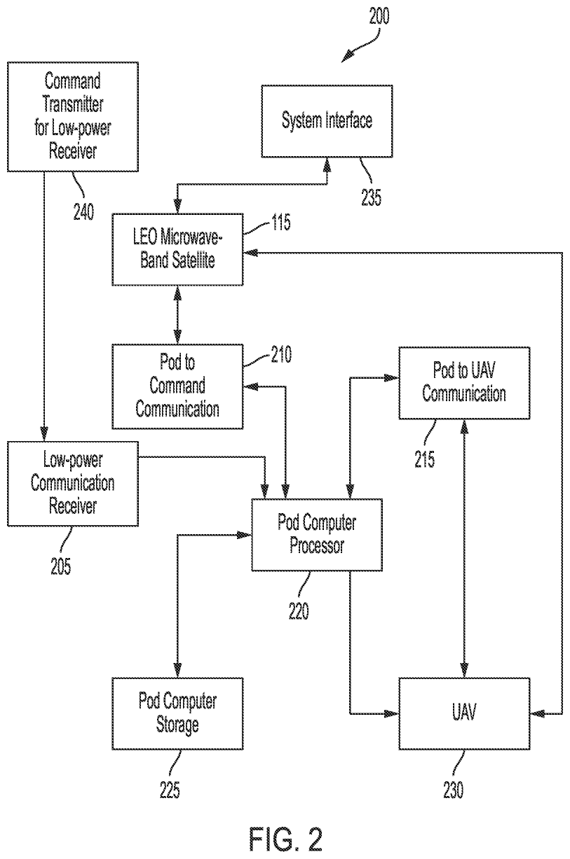

FIG. 2 illustrates example data interconnects of the pod 100, its components, and possible systems external to the pod 100. The low-power receiver 205, active during hibernation, may listen for an external signal or signals generated by the command transmitter for low-power receiver 205. Embodiments of the low-power receiver 205 may support one or a variety of radio, acoustic, or optical signals generated by the command transmitter 240, which can transmit signals on the antenna of low-power receiver 205 acting as a transceiver. In other embodiments, low-power receiver may be high power or be capable of switching between low- and high-power functions depending on any needs in various states of operation. The low-power receiver 205 may be a high-bandwidth receiver or comprise more than one antennae for receiving signals on a broader spectrum or via multiple mediums such as both radio and optical. The capability of receiving signals on multiple frequencies will reduce the likelihood of having a signal being scrambled but increases power consumption by having to monitor several frequencies. The low-power receiver 205 passes the signal on to the pod computer processor 220. Following the receipt of one or more signals or conditions by the pod computer 220, the pod may transition from hibernation to activity.

During activity, the low-power receiver 205 or pod to command communication transceiver 210 may receive signals and pass these on to the pod computer processor 220. The pod computer processor 220 may then store information in the pod computer storage 225 and also store information in one or more of the UAV 230. The UAV 230 may be one or more autonomous drones or missiles, e.g., six UAVs. The information may be geographic information, such as coordinates. The information may be encoded in a variety of ways, including one-time pad encryption, symmetric or asymmetric key encryption, RSA security, AES security, blowfish, or twofish. However, one-time pad encryption can be useful as each UAV 230 may be a single-use device for one contemporaneous mission. Accordingly, each UAV 230 in the pod may have a unique one-time pad to be used once to launch a mission.

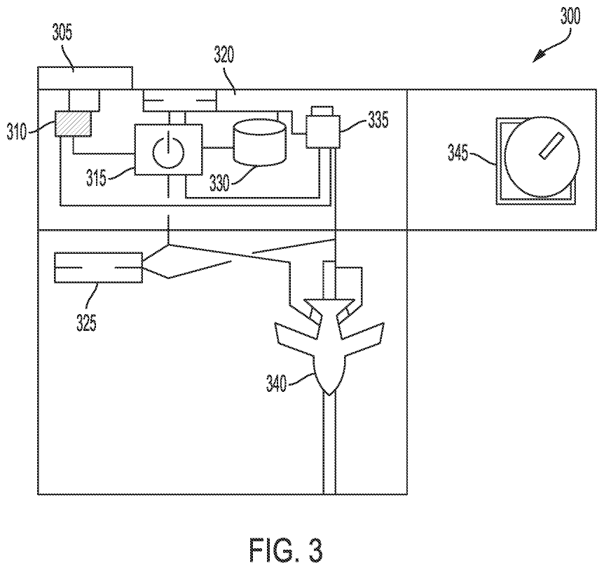

FIG. 3 illustrates a top-down view of example components of the pod 300. In this view, an arrangement of three adjoined waterproof and durable sub-pods are presented. The first pod (top-left) contains the pod electronics systems. The second pod (top-right) contains a satellite communication terminal. The third pod (bottom) contains one or more UAVs. Possible embodiments of a design need not have waterproof separation between the discussed sub-pods nor need they use all described components. Further, sub-pods of possible embodiments need not be adjoined, with connections between sub-pods provided such as by radio or by one or more cables.

In FIG. 3, radio transceiver 305 may be tuned to one or more frequencies, including but not limited to high frequency (HF) and microwave radio. Ultra-low power microcontroller 310 may listen for transmissions received by radio transceiver 305 during any hibernation state of the device. Computer processor 315 may interpret transmissions received by radio transceiver 305 during the non-hibernation period and orchestrates cooperation of other systems during this period. It can be advantageous to have two processors so the ultra-low power microcontroller 310 may be an ASIC that has very basic and low power functionality to monitor for a wakeup command, whereas a more powerful computer processor 315 can be used during the activation period. Heating element 320 may generate heat using chemical or electrical means when temperatures need to increase to ensure proper operation. There may be zero, one or a plurality of heating elements 320 in various embodiments. For example, a separate heating element 325 may be included in a separate pod. Computer data storage device 330 may be a solid state drive or SD card for maintaining program code and data for the sub-pod. Pod power supply unit 335 may be compromised by one or a combination of: primary cell battery, secondary cell battery, or fuel cell, and may be fed in some instances by an external power supply such as a DC outlet or solar panel(s). The design of pod power supply unit 335 will preferably allow for the hibernation period to extend months and even years, possibly by using long-lived and temperature-stable primary cells such with lithium thionyl chloride (LiSOCL2) chemistry. The primary cells may be used to power up any UAVs' secondary cells and, as needed, power a satellite link. These primary cells may remain completely dormant until the power-on signal is received. The total system provisioning may be 260 Wh, with 60 Wh for the munitions and 200 Wh for the link. The one-way receiver may use its own, separate power system to maintain its ultra-low power characteristics.

A high-bandwidth transceiver 345 may be attached in a separate sub-pod. This high-bandwidth transceiver 345 may be a phased-array microwave antenna. This high-bandwidth transceiver 345 is used during the active period. The sub-pod containing high-bandwidth transceiver 345 may open during the active period. The high-bandwidth transceiver 345 may be steerable to track satellites, increasing performance and reliability. UAV 340 may lie dormant during the hibernation state until activated. UAV 340 may be linked to computer processor 315 and/or pod power supply unit 335 in order for electricity and data to be provided, allowing for flights. The kinetic or explosive payload may be onboard UAV 340 during the hibernation period. UAV 340 in the embodiment provided in FIG. 3 may be encapsulated in a sub-pod separate from the computer processor 315 and radio equipment, but this is not required.

Embodiments can optionally include a weather sensor, such as a wind sensor (anemometer), thermometer, UV detector, rain gauge, humidity, wind direction, barometer, or snow sensor. The system may adjust the trajectory of the UAV based on this information. The system may also program the data corresponding to the weather sensor into the UAV so it can adjust its flight path or launch angle to compensate for the weather. For example, if there are high winds, then the UAV may take a path into the wind to compensate for being blown off course. In other embodiments, a centralized weather station may report current weather conditions to the pod, which can apply similar adjustments if the weather sensors are co-located with the pod.

The system may periodically wake from the hibernation state to perform diagnostics, such as to poll or test the battery state of charge. If there is a determination that the battery state of charge drops below a predetermined value, the system may contact a server to transmit a message to a server that the battery is losing charge and needs replacing. This behavior enables someone to come and replace one or more batteries, or perform other maintenance on the system, as these are intended to be placed for several years in case they are needed. In other embodiments, the system may be plugged into a power grid to be able to last even longer. Accordingly, the power supply could either be tied to a power grid or be a battery. The readiness of deployed systems, such as their battery state of charge, may be estimated by statistical sampling. A specific subset of systems may broadcast signals encoding readiness factors such as state of charge, or the systems may be inspected physically. The state of these systems may therefore provide an estimation of the readiness of the remaining, hidden systems.

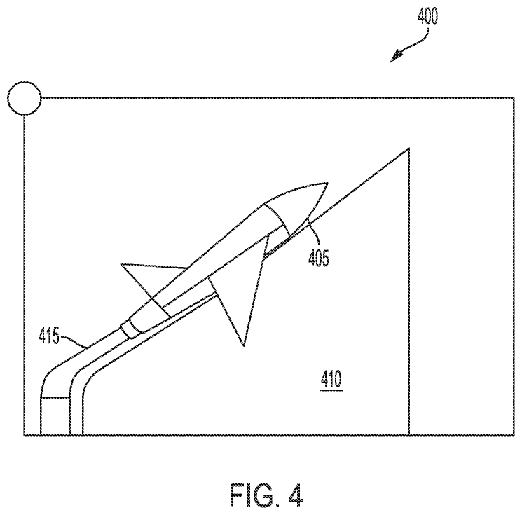

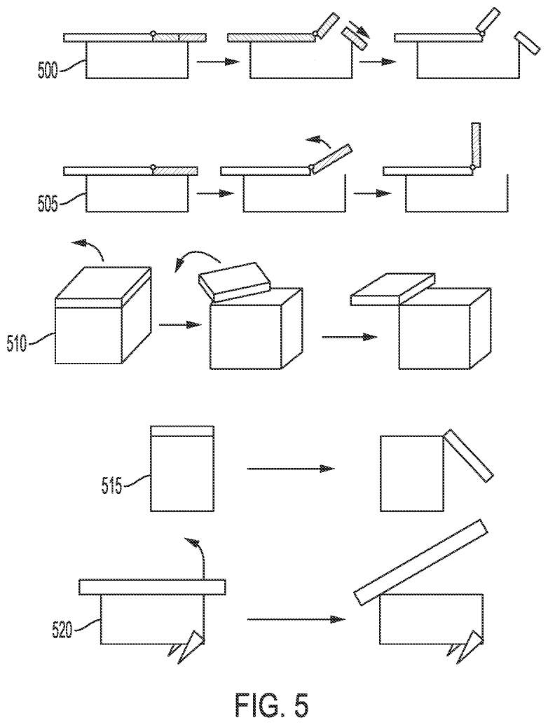

FIG. 4 depicts a side view of a UAV sub-pod 400 embodiment. FIG. 4 shows a UAV 405 aligned on a rail 410 that may provide the UAV 405 a favorable launch angle and stable platform from which to launch. FIG. 4 teaches that, in this embodiment, the UAV 405 has a detachable power and data link 415. The power and data link 415 may charge any secondary cells onboard the UAV 405. The power and data link 415 may upload flight information and routing to the UAV 405. The power and data link may provide two-way communication and control between an operator and the UAV 405, preferably by means of a high-bandwidth transceiver, such as the one illustrated in FIG. 5.

UAV 405 is illustrated in FIG. 4 as a fixed-wing plane, but other embodiments could include a quadcopter, missile, or other custom launch vehicle.

FIG. 5 displays five possible embodiments illustrating unsealing and opening in an active state. Opening is important to allow for UAV takeoff despite a range of weather conditions such as snow, rain, or dust. Opening sequences 500 and 505 illustrate embodiments of the upper lid of the pod opening for an aperture through which one or more UAV may be launched. Opening sequences 510 and 515 illustrate embodiments possibly suited for vertical takeoffs. Opening sequence 520 illustrates another weather-resistant lid opening embodiment, preferably terrestrial, where stakes, bolts or other means affix the pod to the ground. In this way, despite weather conditions, such as high winds, or pod opening embodiment, the pod will remain fixed and stable.

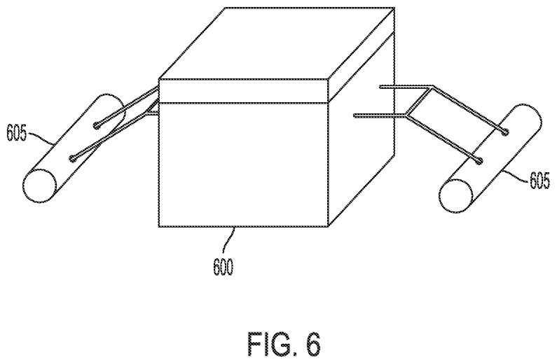

FIG. 6 illustrates a UAV pod 600 comprising two pontoons 605. The pontoons 605 may be retractable and could be used in aquatic embodiments of the pod. The pontoons 605 may be deployed when the UAV pod 600 surfaces in an aquatic environment to provide stability for processing including but not limited to pod opening, UAV launch procedures, and the high-bandwidth transceiver.

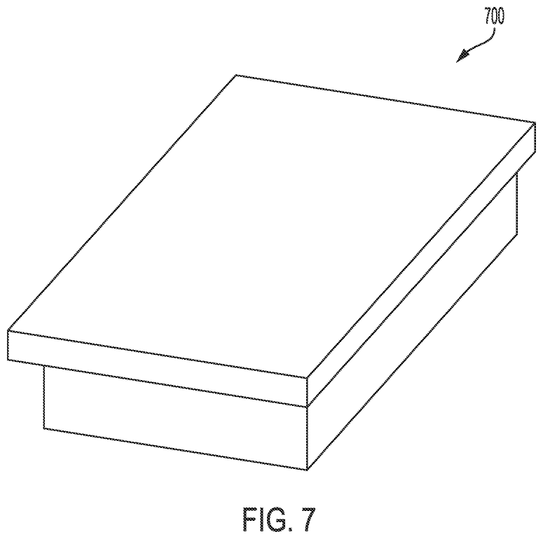

FIG. 7 depicts an embodiment of a terrestrial UAV pod 700 in hibernation. The pod may be waterproof. The top face may overhang the lateral faces to protect the sides from the weather. Each face of the pod may include camouflage and insulation externally or internally. The top face is preferably able to be load-bearing, in the case of buildup including but not limited to particulate, snow, leaves, or other buildup. The unsealing and opening procedure of the UAV pod 700, if partially or fully involving the top face, provides force capable of unsealing and opening even in the event of high load caused by buildup. By overhanging the lateral faces, this embodiment shields the interior of the pod and interior apparatus, such as the UAV, from particulate buildup and weather effects while it is open.

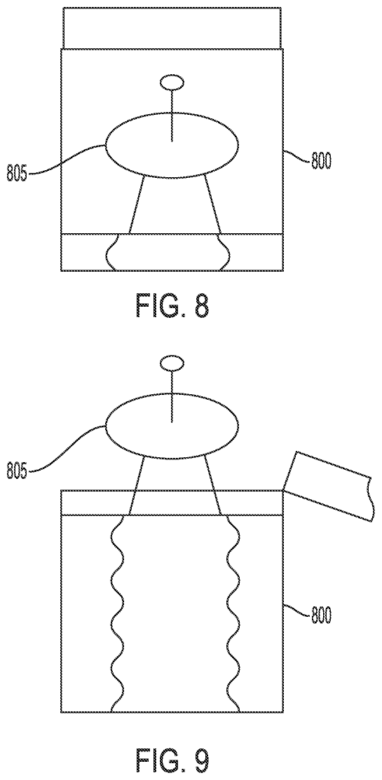

FIG. 8 illustrates a UAV pod 800 in a hibernation state, wherein a high-bandwidth antenna 805 is contained within UAV pod 800. In this way, the high-bandwidth antenna 805 is protected inside of the UAV pod 800 and is ready for use when entering an active state, as illustrated in FIG. 9.

FIG. 9 illustrates UAV pod 800 in an active state, wherein the high-bandwidth antenna 805 is deployed outside of the UAV pod 800 to place it in a better place to receive data. The connection provided by the high-bandwidth antenna may allow for first person view (FPV) data to be relayed from the pod to an external system such as LEO satellite or cellular tower. In conjunction with 305 (or other dedicated UAV communication system), the UAV may be controlled by a distant operator through the high-bandwidth antenna 800 wherein the pod acts as a proxy. Preferable embodiments may implement one or both of high-bandwidth antenna 800 and a low-power receiver 205. Using both allows for the most flexibility in signal-jammed environments or when satellites are offline, as the low-bandwidth antenna may still allow for UAVs to be launched by using locally stored map data.

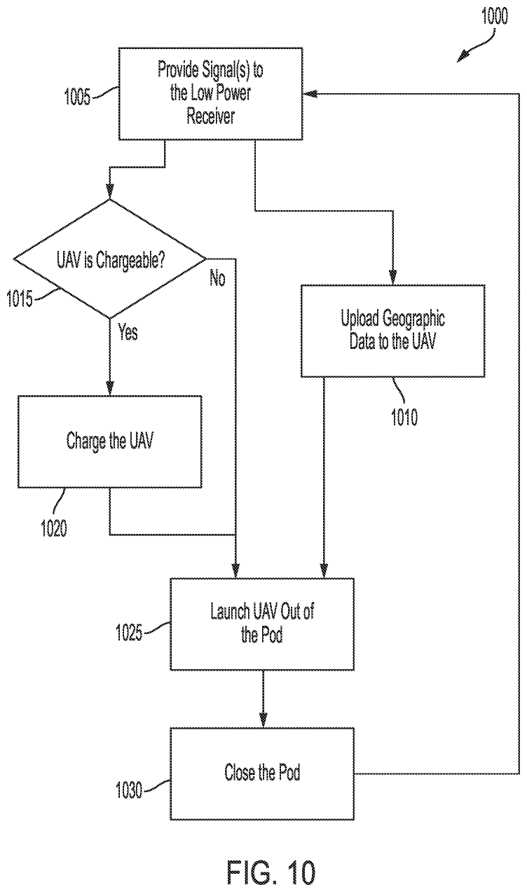

FIG. 10 illustrates a flow diagram 1000 of one embodiment of a system to deploy one or more UAVs during the active states. Initially, the system must be activated by, for example, triggering a switch, to initialize and boot a system. In this embodiment, a low-power receiver can be used to provide the pod with data, while other components that are not needed during the low-power state may be turned off to conserve power. In step 1005, the receiver may monitor one or more frequencies to receive an encrypted command or deployment message: “UAV_NUMBER::GPS_LATITUDE::GPS_LONGITUDE,” which comprises a location identification of location information. The information can correspond to latitude and longitude, or alternatively it can correspond to a proprietary code indicating a location that would not be decodable by an enemy. The proprietary code could correspond to a location on a preprogrammed map stored in the pod or UAV. Accordingly, the pod computer processor may load geographic data from the pod computer storage, possibly process it, and then load the GPS information, a flight plan route, and mission information onto the selected UAV, as illustrated in step 1010. In step 1015, if the UAV is chargeable, the pod computer processor will also direct power from the pod power plant to the selected UAV, as illustrated in step 1020. After data and power upload is complete, the pod will launch the selected UAV, as illustrated in step 1025. In other embodiments, more than one UAV may be launched during the active state. Finally, in step 1030, the pod may close and return to a hibernation or low-power state listening for signals to the low-power receiver to re-enter an active state and launch another UAV.

In some embodiments, a new UAV may be inserted to replace a previous UAV that was deployed. In these embodiments, the pod may be reset from a deployed state to a ready state, signifying that the new UAV is ready to be deployed.

Initial system activation and basic munitions operations may be supported with one-way radios, such as very low frequency (VLF) and high-frequency (HF), that transmit an activation signal to the pod. When deployed, a UAV pod may remain in a low-power, passive listening state. The system may power-on after receiving a one-time on-signal with VLF or HF frequencies. Following this, the system may support one-way commands, such as the following:
Toggle to Two-way radio
Charge secondary cell of munition #X
Deploy munition #X to coordinates {LAT,LONG}
Detonate munitions

First person view (FPV), the primary method of munition operation, will be provided via two-way radio. Following remote system activation, an SoC may bring the system's Starlink terminal online, providing a high bandwidth connection. This link will allow for munitions to be flown and operated remotely via first person view.

“Low-power state,” “Hibernation” and “Hibernation period” are used to reference the periods of time that may last months or years in which the UAV pod uses less electrical power. During these periods, the pod remains closed and preferably waterproof sealed, and the contained UAVs remain latent. Pod electronics during this period may wait for an external signal or condition.

“Activity” and “active period” are used to reference the period of time when the UAV pod uses more electrical power, and preferably this period follows hibernation. During this period, the pod may unseal and open, charge any contained UAVs, launch UAVs, and coordinate the flights of UAVs.

“Receiver” can be only a radio receiver or be the hardware of a transceiver that receives radio signals rather than transmit them. The term “receiver” includes transceivers.

“Primary cell” is used to mean a battery, often a chemical battery, that cannot be recharged. “Secondary cell” is used to mean a battery, often a chemical battery, that can be recharged. Primary cells frequently benefit from long shelf lives and excellent temperature stability as compared to secondary cells.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements may be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Several implementations of the disclosed technology are described above in reference to the figures. The computing devices on which the described technology may be implemented may include one or more central processing units, memory, input devices (e.g., keyboards and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media may comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

Various embodiments described herein are preferably implemented as a special purpose or general-purpose computer including various computer hardware. Embodiments within the scope of the present invention also include non-transitory computer-readable media for carrying or having computer-executable instructions or data structures stored thereon. Such computer-readable media can be any available media which can be accessed by a general purpose or special purpose computer, or downloadable through wireless communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures stored in memory and which can be accessed by a processor of a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the technology provided herein may be applied to other systems, not necessarily the system described above. The elements and acts of the various examples described above may be combined to provide further implementations of the technology. Some alternative implementations of the technology may include not only additional elements to those implementations noted above, but also may include fewer elements.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

I claim:

1. A system comprising:
a processor;
a memory coupled to the processor;
a long-life battery;
a receiver coupled to the processor and the memory;
a launch vehicle;
the processor configured to execute instructions stored in memory, the instructions comprising:
entering into a low-power state after boot, wherein the low-power state allows the long-life battery to maintain charge for at least five years;
monitoring periodically for a deployment message comprising a location identification;
writing the location identification to a second memory of the launch vehicle; and
launching the launch vehicle.

2. The system of claim 1, wherein the system comprises a waterproof container.

3. The system of claim 1, wherein the processor is further configured to execute instructions comprising:
polling periodically a state of charge of the long-life battery;
determining that the state of charge of the long-life battery has dropped below a predetermined value; and
transmitting, in response to the determination, a message to a server indicating that the state of charge of the long-life battery has dropped below the predetermined value.

4. The system of claim 1, wherein the deployment message is encrypted.

5. The system of claim 1, wherein the memory comprises a preprogrammed map of a target area.

6. The system of claim 1, wherein the receiver is a high-bandwidth receiver.

7. The system of claim 1, wherein the system comprises a weather sensor.

8. The system of claim 7, wherein the processor is further configured to execute instructions comprising:
store, by the processor in a memory of the launch vehicle, a message corresponding to data read from the weather sensor.

9. The system of claim 7, wherein the processor is further configured to execute instructions comprising:
adjust, by the processor, a launch angle of the launch vehicle in response to data read from the weather sensor.

10. A non-transitory computer-readable medium containing instructions capable of being performed on a processor, the instructions comprising:
activating, via a switch, a launch system comprising one or more unmanned aerial vehicles (UAVs), one or more power supplies, the processor, a waterproof container, and a low-power receiver;
entering, by a processor, a low-power state after activating;
receiving, at the low-power receiver, an activation signal comprising location information;
opening, by the processor, the waterproof container;
uploading, by the processor, at least a portion of the location information into the one or more of UAVs; and
launching, by the processor, the one or more UAVs.

11. The non-transitory computer-readable medium containing instructions capable of being performed on a processor of claim 10, the instructions further comprising: closing, by the processor, the waterproof container after launching the one or more UAVs.

12. The non-transitory computer-readable medium containing instructions capable of being performed on a processor of claim 10, the instructions further comprising:
polling periodically, by the processor, a state of charge of a power supply;
determining that the state of charge of the power supply has dropped below a predetermined value; and
transmitting, in response to the determination, a message to a server indicating that the state of charge of the power supply has dropped below the predetermined value.

13. The non-transitory computer-readable medium containing instructions capable of being performed on a processor of claim 10, wherein the activation signal is encrypted.

14. The non-transitory computer-readable medium containing instructions capable of being performed on a processor of claim 10, wherein the launch system further comprises a memory including a preprogrammed map of a target area.

15. The non-transitory computer-readable medium containing instructions capable of being performed on a processor of claim 10, wherein the launch system further comprises a high-bandwidth receiver.

16. The non-transitory computer-readable medium containing instructions capable of being performed on a processor of claim 10, wherein system further comprises a weather sensor.

17. The non-transitory computer-readable medium containing instructions capable of being performed on a processor of claim 16, the instructions further comprising:
storing, by the processor in a memory of the one or more UAVs, a message corresponding to data read from the weather sensor.

18. The non-transitory computer-readable medium containing instructions capable of being performed on a processor of claim 17, the instructions further comprising:
adjusting, by the processor, a launch angle of the one or more UAVs in response to data read from the weather sensor.

19. The non-transitory computer-readable medium containing instructions capable of being performed on a processor of claim 10, the instructions further comprising:
resetting, by the processor, a state of a UAV from a deployed state to a ready state in response to receiving a new UAV in a location where a previous UAV was launched.

20. The non-transitory computer-readable medium containing instructions capable of being performed on a processor of claim 10, the instructions further comprising:
reentering, by the processor, the low-power state after launching the one or more vehicles.
